(19) United States
(12) Patent Application Publication
(10) Pub. No.: US 2016/0107197 A1
(43) Pub. Date: Apr. 21, 2016

(54) METHOD AND DEVICE FOR SEPARATING PRIMARY ORE CONTAINING RARE EARTHS

(71) Applicant: SIEMENS AKTIENGESELLSCHAFT, 80333 München (DE)

(72) Inventors: WERNER HARTMANN, WEISENDORF (DE); KILIAN NEUBERT, AACHEN (DE); SONJA WOLFRUM, ERLANGEN (DE); HERMANN WOTRUBA, AACHEN (DE)

(73) Assignee: SIEMENS AKTIENGESELLSCHAFT, 80333 München (DE)

(21) Appl. No.: 14/897,874

(22) PCT Filed: May 16, 2014
(86) PCT No.: PCT/EP2014/060140

§ 371 Date: Dec. 11, 2015

(30) Foreign Application Priority Data
Jun. 14, 2013 (DE) 102013211184.3

(51) Int. Cl. B07C 5/34; B02C 23/08

(52) U.S. Cl. CPC B07C 5/3416; B02C 23/08

(57) ABSTRACT

The invention relates to a method and devices for separating primary ore into dead rock and at least one type of rock which contains at least one valuable mineral, the at least one valuable mineral comprising at least one rare-earth mineral. A sensor-controlled pre-framing method, which is based on the identification and classification of individual rock particles, is used.

The invention relates to a method and a system for separating primary ore into dead rock and at least one rock which is enriched with at least one valuable mineral, wherein the at least one valuable mineral comprises at least one rare earth mineral. The invention also relates to a sorting device for separating rock particles composed of primary ore into dead rock and at least one type of rock which is enriched with at least one valuable mineral, wherein the at least one valuable mineral comprises at least one rare earth mineral, and wherein the rock particles comprise dead rock particles composed of, or mainly composed of, dead rock, and also valuable mineral particles composed of, or mainly composed of, rock which is enriched with a valuable mineral.

Primary ore deposits or hard rock deposits for mining rare earths generally only have small amounts of valuable materials or rare earths. The elements of the rare earths are found in complex ore structures, within finely intergrown minerals. In addition, all the types of ore which are extracted usually have naturally occurring radioactivity, since minerals in which rare earths are contained are frequently enriched both with thorium as well as uranium. These properties of the rare earth deposits have the result in many cases that ecological or economic mining of these types of deposits is made difficult or impossible.

The finely intergrown minerals are usually comminuted with a high input of energy before the actual enrichment or concentration of the rare earths by means of physical preparation techniques. For the comminution, the ores are firstly crushed and subsequently comminuted by milling to a granular size in which a sufficient degree of disintegration of the valuable minerals is achieved. The degree of disintegration indicates here the percentage of the valuable mineral which is present in a free state in the individual particle and can therefore be separated from the dead rock. After the disintegration, the valuable minerals can be separated from the dead rock. During these preparation processes, large quantities of water and reagents are necessary. The entire, finely milled dead rock is deposited. In the case of surface preparation this can lead to a large area being taken up and the environment can be damaged by the depositing of materials with a high proportion of undesired components.

The low efficiency levels of the known enrichment processes, which result in low yields of the valuable minerals, are problematic. The yield represents here the percentage of the valuable mineral which can be acquired from the primary ore by means of a technical sorting process. The lower the yield, the more valuable mineral remains in the recovery stream and is therefore lost.

In order to prepare primary ores containing rare earth minerals such as bastnaesite or monazite, at present exclusively conventional preparation technologies are used. In the primary ore deposits or hard rock deposits, the entire material stream is crushed before the actual enrichment of the valuable minerals, and milled to a floating grain size, generally to granular sizes of less than 150 μm, as a result of which large quantities of energy have to be applied. In the usually subsequent flotation, which is a separating process in which the different surface properties of the minerals are used as separating criteria, water and reagents are used in order to separate the valuable minerals from the dead rock. High costs for the water preparation, a large area and environmental problems are caused by the content of flotation reagents and noxious substances in the seepage.

A flowchart of a preparation system for Mountain Pass, a primary ore deposit containing rare earth minerals in California, is presented by C. K. Gupta and N. Krisnamurthy in “Extractive Metallurgy of Rare Earths”, 2005, CRC Press, page 141.

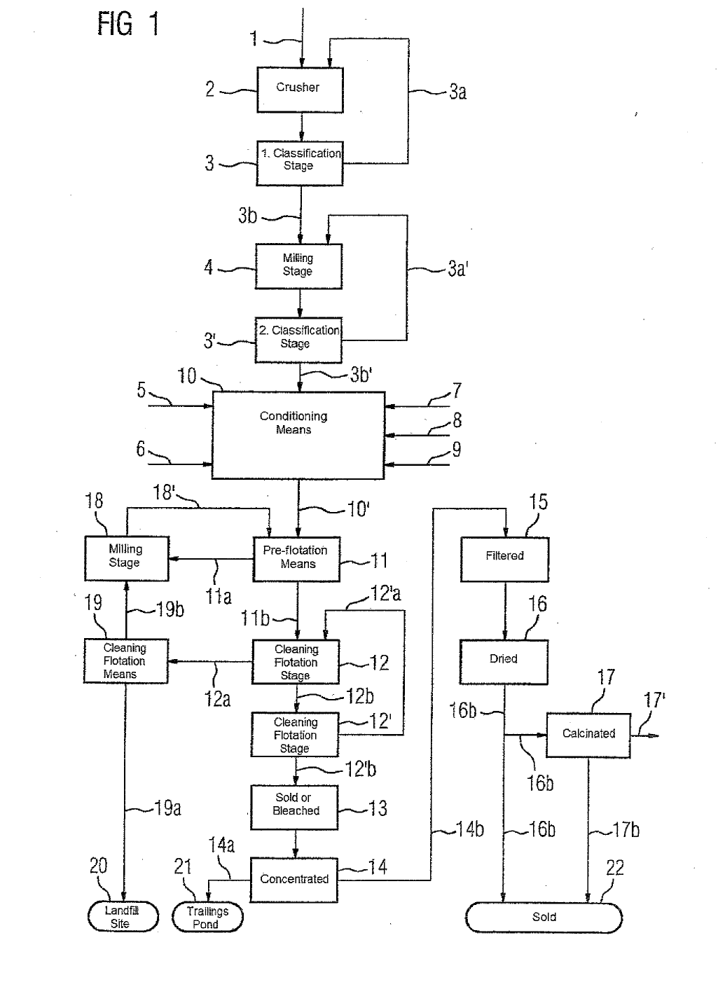

FIG. 1 shows a simplified flowchart, derived therefrom, of an exemplary preparation system such as would be implemented by a person skilled in the art at present. The entire stream of primary ore 1 is comminuted to a granular size of 80% <150 μm by crushing, milling or classification processes. For example, the primary ore can, as shown in FIG. 1, be crushed in a crusher 2 and fed to a subsequent first classification stage 3 in order to separate off excessively coarse rock particles 3a and feed them back into the crusher 2. The other rock particles 3b are preferably fed to a milling stage 4 and milled to a granular size of approximately 150 μm. In certain circumstances there is a subsequent second classification stage 3′ in which further excessively coarse rock particles 3a′ are separated off and fed back in to the milling stage 4. The other rock particles 3b′ are fed as a component of a pulp to a conditioning means 10 or flotation means 11, 12, 12′ in order to be separated there into dead rock and valuable minerals. During the conditioning 10 of the pulp, in particular water vapor 5, ammonium lignosulfonate 6, distilled tall oil 7, sodium carbonate 8 and fluorosilicate 9 are added to the pulp. The conditioned pulp 10′ is then fed to a pre-flotation means 11, wherein the pre-flotation concentrate 11b which is formed is fed to one or more subsequent cleaning flotation stages 12, 12′. The pre-flotation waste stram 11a is fed to a subsequent milling stage 18 and is subsequently fed back again to the pre-flotation means 11. The waste stream 12a of the first cleaning flotation stage 12 is fed to a subsequent cleaning flotation means 19, wherein the subsequent cleaning flotation concentrate 19b which is formed there is also fed to the subsequent milling stage 18. As a result, the yield of valuable material, here of rare earth minerals, is increased.

The subsequent cleaning flotation waste stream 19a is stored in a landfill site 20.

The concentrate stream 12b which originates from the first cleaning flotation stage 12 is, if appropriate, fed to at least one further cleaning flotation stage 12′. Separated-off waste streams 12a′ from further cleaning flotation stages 12′ are fed back in to the first cleaning flotation stage 12 here.

The concentrate stream 12b′ which is present at the end of the cleaning flotation stage 12, 12′ (usually with a concentrated proportion of rare earth mineral of approximately 60%) is either sold or leached 13 with 10% HCl, concentrated 14 and the water 14a extracted in the process is directed into a tailings pond 21. The concentrated concentrate stream 14b is filtered 15 and the filter residue subsequently dried 16. The dried concentrate 16b containing approximately 70% valuable mineral or rare earth mineral is directly sold 22 or calcinated 17 by splitting of CO₂ 17′, and the calcinated concentrate 17b then containing approximately 90% valuable mineral or rare earth mineral is sold 22.

The disintegration and the enrichment of the ores containing rare earths is therefore problematic, since, owing to the usually only low concentration of the rare earth minerals in the primary ore, a high energy requirement and resource consumption is necessary to obtain small quantities of rare earth mineral.

The object of the invention is therefore to make available a more efficient and at the same time less environmentally damaging method for enriching rare earth minerals containing valuable minerals, and to specify devices suitable for this, and the use thereof.

The object is solved for the method for separating primary ore containing rare earths into dead rock and at least one rock which is enriched with at least one valuable mineral, wherein the at least one valuable mineral comprises at least one rare earth mineral, having the following steps:

comminuting the primary ore into rock particles with a particle size in the range from >1 mm to 300 mm, wherein the rock particles comprise dead rock particles composed of, or mainly composed of, dead rock, and also comprise valuable mineral particles composed of, or mainly composed of, rock which is enriched with a valuable mineral;
separating out the rock particles;
feeding the separated-out rock particles to at least one measuring unit;
measuring at least one primary and/or secondary rock property of each rock particle by means of the at least one measuring unit, wherein at least two different rock properties of a rock particle are determined, and assigning the at least one measured rock property to the respective rock particle;
classifying each rock particle as a function of its rock properties as a dead rock particle or valuable mineral particle; and
separating the dead rock particles from the valuable mineral particles.

The method according to the invention uses sensor-supported pre-sorting of coarse rock particles according to the principle of individual particle detection, as a result of which separating out and suitable feeding of the separated-out rock particle to the at least one measuring unit has to take place.

According to the invention, the high consumption of resources for the disintegration and the enrichment of the valuable mineral containing the rare earth minerals is therefore reduced by upstream, sensor-supported sorting. The valuable minerals located in the primary ore stream are therefore already pre-concentrated by sensor-supported pre-separation after the crusher and before the entry into a preparation system, usually a milling stage downstream of the crusher. Dead rock is separated at the earliest possible point in the process stream from valuable ore, and the valuable mineral is therefore concentrated before entry into the preparation system. As a result, the material stream, that is to say the quantity of rock particles 3b, which has to be channeled through the process, is reduced significantly, cf. here FIG. 1.

The energy requirement for the process is therefore decreased and fewer resources, in particular water and chemicals, are required.

The costs for the transportation of the extracted valuable minerals to the preparation system are lowered and the input of energy for the comminution, in particular the milling, is reduced. In addition, the high input of environmentally damaging reagents in the subsequent process steps is lowered and the degree of efficiency of existing processes is increased by the early enrichment of the rare earth minerals.

The extraction of specific deposits which have hitherto been categorized as not worthy of extraction for ecological and economic reasons can therefore now be considered. As a result, resources can be converted into reserves. Originally uneconomic deposits are therefore converted into economically extractable reserves.

The throughput of sensor-supported pre-sorting is dependent directly on the granular size of the material to be sorted, as a result of which an excessively small granular size leads to a situation in which economic separation of the minerals with sufficient throughput of the sorters is not possible. Therefore, the invention concentrates essentially on the use of sensor-supported pre-sorting in the region of primary ore deposits.

Since the range of granular sizes in secondary ore deposits in which the rare earth minerals are contained in heavy mineral sands is usually below 1 mm granular size, with the current prior art sensor-supported pre-sorting for separation is possible to a lesser degree or only in exceptional cases with this type of deposits. Although the classification of particles of this size is possible with contemporary sensors, the mechanical separation of such particles is still difficult to implement, or cannot be implemented economically.

In the case of rare earth minerals, the low content and the fine distribution of the rare earth elements in the primary ore, together with difficult or slow detection of the rare earth elements by existing sensors make rapid detection more difficult. This makes sufficiently rapid identification of the properties of individual particles difficult. This leads to a situation in which efficient separation of the dead rock is impeded.

For the method it is therefore preferred if at least two different rock properties of an individual rock particle are determined, wherein two or more primary rock properties, two or more secondary rock properties or simultaneously primary and secondary rock properties of each rock particle are determined by means of the at least one measuring unit.

In particular, what are referred to as secondary rock properties are used for classifying the minerals in the ore stream. In this context, the rare earth elements are not detected primarily but instead indicators are detected which can be used for identifying valuable rock and dead rock. This includes all measurable values which do not constitute rare earth elements directly. When such secondary identification properties are used as separating criterion it is, however, necessary that, for the classification of individual rock particles, there is a sufficient correlation between the content of valuable material and the indicator.

In this context it is possible to use, for the separation of the primary ore, a wide variety of sensor units which all permit the classification by means of different material properties on the basis of the electromagnetic spectrum.

It has proven valuable for the method if the type of at least one included valuable mineral and/or valuable mineral content is determined as a primary rock property. Therefore, primary properties which are directly related to the actually included rare earths or rare earth element or elements are sensed here. Alternatively, the content of rare earths overall or else of individual rare earth elements, or of a plurality thereof, could be sensed.

An atomic density and/or a magnetic susceptibility and/or at least one visual property, in particular a color and/or a natural radioactivity and/or the type and/or a content of accompanying minerals, alteration minerals or elements which occur associated with the at least one rare earth mineral are preferably determined as a secondary rock property.

In order to concentrate rare earth minerals, in particular visual properties and/or the magnetic susceptibility of accompanying minerals or alteration minerals or the content thereof are used as a possible indicator for the presence of rare earths, and as a result efficient separation of dead rock is made possible.

In particular, it has proven here to determine the lime content of a rock particle. In the case of lime-rich rock particles, it can frequently be concluded that said particle is also rich in bastnaesite, while rock particles which are low in lime are usually rich in monazite. Furthermore, it has proven valuable to measure the content of iron or silicon of a rock particle and to draw conclusions therefrom about its content of light or heavy rare earth elements.

The calcium content can also serve as an indicator in the case of a bastnaesite.

Overall, the available indicators are, however, determined as a function of the conditions in a specific deposit.

The rare earths usually occur in nature in an oxidic form (for example as carbonates, phosphates) in various minerals. The minerals bastnaesite, monazite and xenotime form here approximately 95% of the worldwide reserves of rare earths. It is characteristic of these minerals that the rare earth elements are present in association with one another, i.e. the minerals usually contain the entire spectrum of rare earth elements. In general, the rare earth elements are divided into light and heavy rare earth elements, wherein lanthanum, cerium, praseodymium, neodymium, gadolinium, samarium and europium are some of the light rare earth elements, and terbium, dysprosium, holmium, erbium, thulium, ytterbium, lutetium and yttrium are classified as heavy rare earth elements. The respective composition varies depending on the type of mineral and deposit. Therefore, for example xenotime has a very high content (approximately 80%) of heavy rare earth elements, whereas bastnaesite and monazite contain predominantly light rare earth elements.

In primary ores containing rare earths, the individual minerals are usually finely intergrown with one another, and the total content of rare earths in the ore is only low. As a result of the comminution of the primary ore, the valuable minerals in the ore are exposed. The necessary comminution expenditure to disintegrate the valuable minerals varies as a function of the granular-size specific degree of intergrowth of the valuable minerals. The finer an ore has to be milled, the higher the specific energy costs for the comminution. This can lead to considerable energy costs for the comminution in the case of finely intergrown ores. In addition, large areas for the depositing of the quantities of valueless, fine dead material are required. As a result of the association of the rare earth elements, after the preparation the individual rare earth oxides have to be separated from one another by very costly separation methods after the enrichment in the concentrate. This requires a large amount of acids and lyes and therefore has an enormous environmental impact. As a result of the high degree of similarity between the various rare earth elements in terms of their chemical behavior, the separation is extremely costly. On a large scale, liquid/liquid extraction is usually used for the separation. This separating method is based on the different solution behavior of the substances into two non-mixable solvents.

In addition, usually radioactive accompanying substances such as thorium and uranium are intergrown with the rare earths, which accompanying substances can also be exposed and enriched during the preparation. These components have to be deposited after separation has taken place, which also results in serious risks for the environment. Owing to the specified ecological and economic problems, many deposits are currently not exploited.

It is therefore particularly preferred to separate the stream of valuable mineral particles which is obtained also into first valuable mineral particles and second valuable mineral particles, wherein the first valuable mineral particles are enriched with heavy rare earth elements, and the second valuable mineral particles are enriched with light rare earth elements. In this context, essentially the rock properties already described above of the individual valuable mineral particles are evaluated in order to obtain a suitable separation criterion here. In this context, the separation into first and second valuable mineral particles can occur directly during the separation of the dead rock or can be carried out only subsequently on the already separated-off stream of valuable mineral particles.

According to the invention, as a result deposits whose extraction with the present state of the art is uneconomic can prove to be economically viable in the future. As a result of the pre-sorting, there is a saving in resources in terms of energy (for example for the comminution), water and reagents (for example for the flotation).

As a result of early separation of coarse rock particles which have different contents of heavy and light rare earths, the preparation and the subsequent extraction of the individual substances from the mineral concentrate can be made more efficient. It is therefore possible, for example, to adapt the milling and sorting selectively for each fraction of valuable mineral particles which are enriched either with heavy or light rare earths to the respective fraction. As a result it is possible to lower the energy costs which are incurred and to adapt the sorting processes to the different mineral properties, as a result of which the possible yield of valuable materials can be increased. Pieces of ore with only relatively low contents of heavy rare earths can be treated, or entirely discarded, in differing method routes.

In the case of liquid/liquid extraction, the pre-sorting into such valuable mineral particle fractions can by means of sensor-supported sorting reduce the number of necessary separating stages for the separation of the included rare earth oxides. In addition to the relatively low expenditure on apparatus, this gives rise to lower consumption of chemicals and to a shorter processing time. It would also be alternatively conceivable that in the case of an already existing system the various concentrate streams, which are enriched either with light or heavy rare earth elements, to be fed to different points on the separating cascade. Therefore, the respective concentrate does not have to pass through all the stages, and costs can also be saved through the reduced processing time and the reduced requirement of chemicals.

In particular, for this method deposits are possible in which, as a result of the formation history or weather conditions mineralogically different regions with increased content of light or heavy rare earth elements are present one next to the other. An example of this are xenoliths which can be enriched locally with light or heavy rare earth elements to differing degrees.

The object of the invention is also achieved by means of a device in the form of a sorting device for separating rock particles composed of primary ore into dead rock and at least one rock which is enriched with at least one valuable mineral, wherein the at least one valuable mineral comprises at least one rare earth mineral, and wherein the rock particles comprise dead rock particles which are composed of, or mainly composed of, dead rock, and also valuable mineral particles composed of, or mainly composed of, rock which is enriched with a valuable mineral, wherein the sorting device comprises:

at least one separating-out unit for separating out the rock particles,
at least one measuring unit for analyzing at least one primary and/or secondary rock property of each rock particle and for assigning the at least one rock property to the respective rock particle,
at least one evaluation unit for classifying each rock particle as a function of its rock properties as a dead rock particle or a valuable mineral particle, and
at least one separating unit for separating the dead rock particles from the valuable mineral particles.

According to the invention, such a sorting device follows, during processing of primary ores, a crusher or a comminution unit which pre-comminutes the primary ore to a particle size in the range from >1 mm to approximately 300 mm. The dead rock particles which are separated off by the sorting device can accordingly be separated off and deposited immediately after they leave the sorting device. The remaining, correspondingly smaller stream of valuable mineral particles is then fed to a milling stage and further processed, for example, according to FIG. 1, starting from the milling stage 4. Owing to the smaller mineral stream to be processed, the processing system components which are arranged downstream of the sorting device can be given correspondingly smaller dimensions and operated more efficiently in terms of energy.

The object of the invention is also achieved by means of a system for separating primary ore into dead rock and at least one rock which is enriched with at least one valuable mineral, wherein the at least one valuable mineral comprises at least one rare earth mineral, wherein this system comprises:

at least one crusher for comminuting the primary ore into rock particles, wherein the rock particles comprise dead rock particles composed of, or mainly composed of, dead rock, and also valuable mineral particles composed of, or mainly composed of, rock which is enriched with a valuable ore,
at least one sorting device,
at least one transfer region for transferring the rock particles to at least one sorting device,
at least one separating-out unit for separating out the rock particles in the at least one transfer region and/or in the region of the at least one sorting device,
at least one measuring unit in the region of the at least one sorting device for measuring at least one primary and/or secondary rock property of each rock particle and for assigning the at least one measured rock property to the respective rock particle,
at least one evaluation unit for classifying each rock particle as a function of its rock properties as a dead rock particle or valuable mineral particle, and
at least one separating unit for separating the dead rock particles from the valuable mineral particles.

The term “crusher” is representative here of all comminution units which are capable of decomposing primary ore into rock particles with a particle size in the range from >1 mm to approximately 300 mm. dimensions of the system components downstream of the sorting device of the system, such as, for example, the milling stages and classification stages, flotation stages etc. correspondingly smaller and to operate the system more efficiently in terms of energy.

The preferred embodiments of the invention which are specified below relate in the same way to the sorting device according to the invention as to the system according to the invention.

The at least one separating unit is also configured, in a particularly preferred embodiment of the invention, to separate the valuable mineral particles into first valuable mineral particles and second valuable mineral particles, wherein the first valuable mineral particles are enriched with heavy rare earth elements, and the second valuable mineral particles are enriched with light rare earth elements.

A chute-type sorter, which separates out the rock particles, is preferably present as the separating-out unit. As an alternative to a chute-type sorter, a belt-type sorter can be used as the separating-out unit.

In one particularly preferred embodiment of the invention, the measuring unit comprises at least two sensors for sensing different rock properties of a rock particle. As a result, clearer sorting decisions can be made and more precise sorting criteria can be acquired because they are multi-dimensional.

In particular, the at least one measuring unit comprises at least two sensor units for analyzing different rock properties of a rock particle. In particular, in this context both at least one primary and at least one secondary rock property of a rock particle are sensed in order to perform classification. Likewise, it is, however, possible to sense a plurality of primary or a plurality of secondary rock properties. In this context, a sensor unit preferably comprises at least one emitter unit and/or at least one detector unit.

A sensor unit preferably comprises at least one analysis device from the group comprising optical analysis devices, NIR analysis devices, X-ray analysis devices, X-ray fluorescence analysis devices, devices for analyzing by means of ionizing radiation, radiometric analysis devices, inductive analysis devices, LIBS analysis devices, microwave analysis devices etc.

In this context, it is possible to use exclusively active sensor units such as NIR sensor units or X-ray transmission sensor units, or passive sensor units such as susceptibility sensor units or radiometric sensor units.

In an active sensor unit, a rock particle is excited actively by the emission of radiation, and transmitted or reflected radiation is sensed by means of at least one detector unit. In contrast, a passive sensor unit uses exclusively the properties of a rock particle per se, without performing excitation beforehand by means of electromagnetic radiation. A combination of active and passive sensor units is also possible.

Combinations of sensor units within one measuring unit or in separate measuring units particularly preferably comprise the following analysis devices:

a) an analysis device for optical color detection in combination with a radiometric analysis device
b) an NIR analysis device in combination with an analysis device for optical color detection
c) an analysis device for optical color detection in combination with a radiometric analysis device and also an NIR analysis device.

The at least one measuring device can be arranged above and/or below a transportation device such as, for example, a transportation belt, for the separated-off rock particles.

The use of a sorting device according to the invention for separating rock particles from primary ore into dead rock and at least one rock which is enriched with at least one valuable mineral has proven valuable, wherein the at least one valuable mineral comprises at least one rare earth mineral in a concentration of greater than 0.1%, in particular greater than 0.5%.

Furthermore, the use of a system according to the invention for separating primary ore into dead rock and at least one rock which is enriched with at least one valuable mineral has proven valuable, wherein the at least one valuable mineral comprises at least one rare earth mineral in a concentration of greater than 0.1%, in particular of greater than 0.5%.

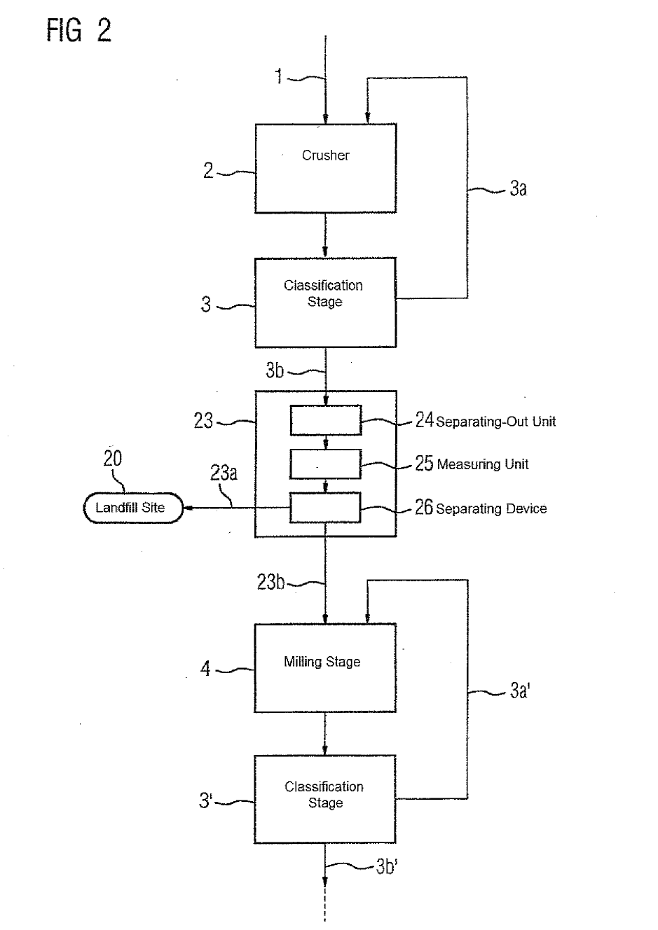

FIGS. 2 to 5 are intended to explain the invention by way of example. In the drawings:

FIG. 2 shows a method for separating primary ore,

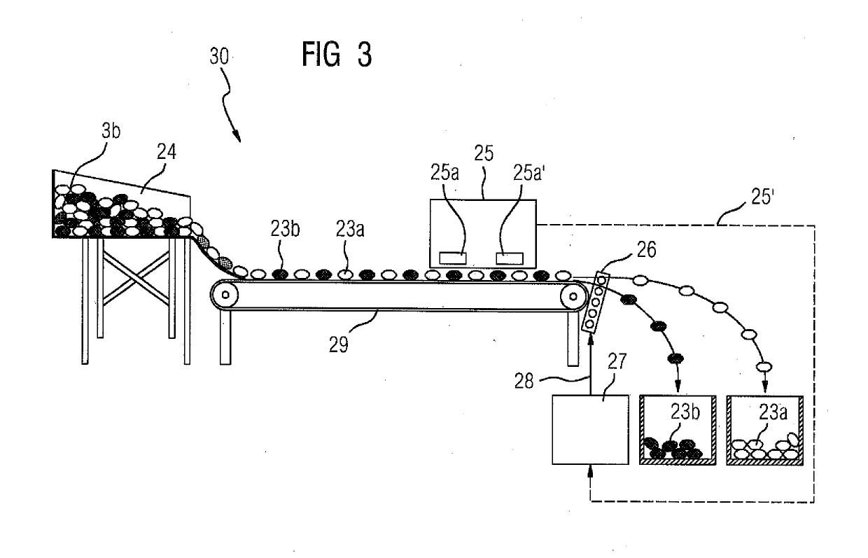

FIG. 3 shows a sorting device for separating rock particles,

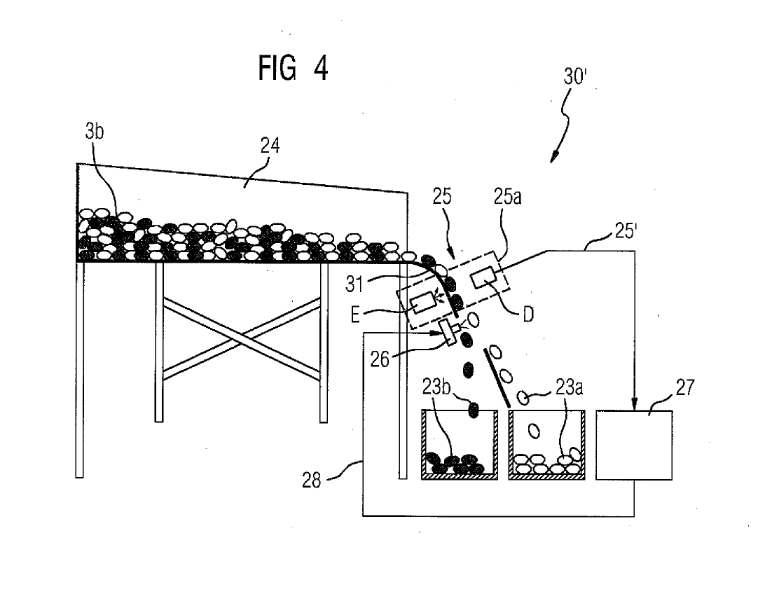

FIG. 4 shows a further sorting device for separating rock particles,

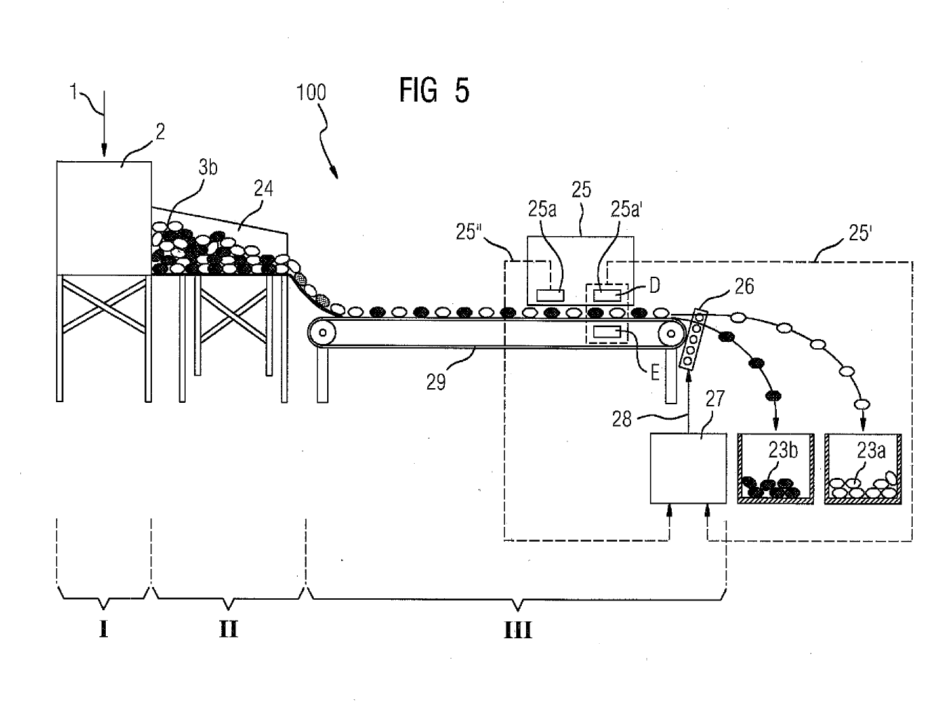

FIG. 5 shows a system for separating primary ore into dead rock and into a type of rock which is enriched with a valuable mineral, and

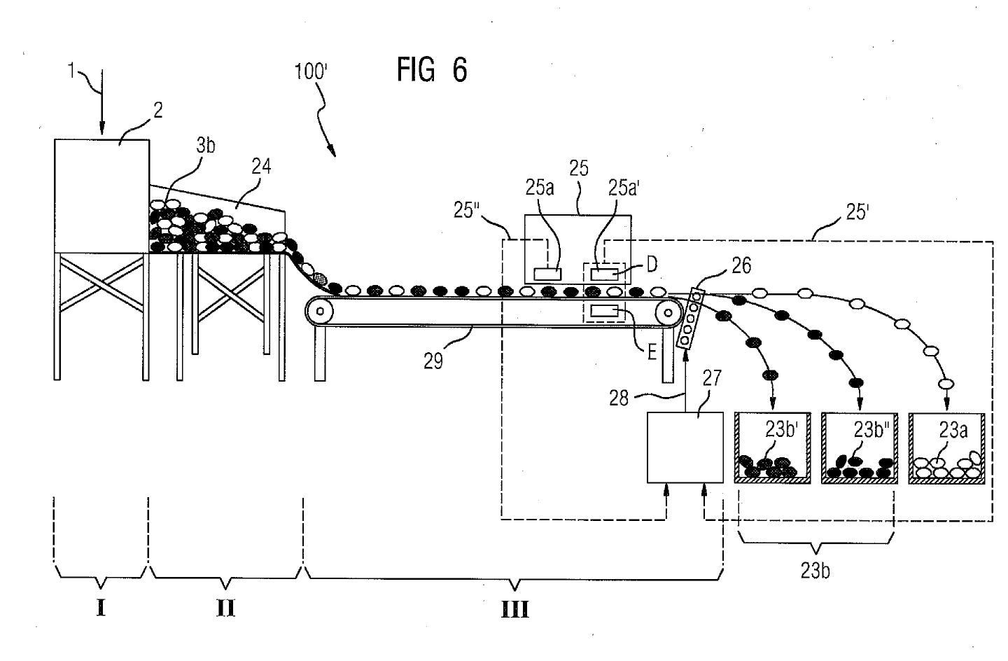

FIG. 6 shows a further system for separating primary ore into dead rock and into a type of rock which is enriched with a valuable mineral, wherein separation also occurs into fractions of valuable mineral particles with different contents of light and heavy rare earth elements.

FIG. 2 shows a method for separating primary ore 1 into dead rock 23a and into a type of rock 23b which is enriched with a valuable mineral, wherein the valuable mineral comprises at least one rare earth mineral. The primary ore 1 is comminuted into rock particles 3b with a particle size in the range from >1 mm to 300 mm, wherein the rock particles 3b comprise dead rock particles 23a composed of, or mainly composed of, dead rock, and also valuable mineral particles 23b composed of, or mainly composed of, a type of rock which is enriched with a valuable mineral. Excessively coarse rock particles 3a are removed in the classification stage 3 and fed back into the crusher 2. The rock particles 3b correspond here to the rock particles 3b according to FIG. 1. However, in contrast to the method shown by way of example in FIG. 1, according to the invention pre-sorting 23 now takes place. In this context, the rock particles 3b are separated out by means of a separating-out unit 24 and fed to at least one measuring unit 25. By means of this measuring unit 25, at least one primary and/or secondary rock property of each rock particle 3b is sensed and the sensed rock property or properties is/are assigned to the respective rock particle 3b. Each rock particle 3b is then classified as a function of its rock properties as a dead rock particle 23a or valuable mineral particle 23b, and the dead rock particles 23a are separated from the valuable mineral particles 23b by means of a separating device 26. The valuable mineral particles 23b are then fed into the milling stage 4 and also pass through, for example, the process illustrated in FIG. 1 starting from the milling stage. The dead rock particles 23a are fed to the landfill site 20 and no longer unnecessarily act as a burden on the further processing. A saving in energy for the method steps which occur starting from the milling stage and a reduced requirement of water and chemicals are obtained as advantages.

FIG. 3 shows a sorting device 30 in the form of a belt-type sorter for separating rock particles 3b from primary ore into dead rock and into a rock which is enriched with at least one valuable mineral, wherein the at least one valuable mineral comprises at least one rare earth mineral, and wherein the rock particles 3b comprise dead rock particles 23a composed of, or mainly composed of, dead rock and also valuable mineral particles 23b composed of, or mainly composed of, rock which is enriched with a valuable mineral. The sorting device 30 comprises here a separating-out unit 24 for separating out the rock particles 3b in the form of a chute in combination with a transportation belt 29. A difference in the transportation speeds of the rock particles 3b in the region of the chute and of the transportation belt 29 causes the rock particles 3b to be separated out. The rock particles 3b pass successively from the chute onto the transportation belt 29 and are successively fed to a measuring unit 25. The latter serves to analyze at least one primary and/or secondary rock property of each rock particle 3b and to assign at least one rock property to the respective rock particle 3b. The sensor-supported sorting is based on the principle of individual grain detection.

The measuring unit 25 has here, for example, two different sensor units 25a, 25a′ such as, for example, a first sensor unit 25a in the form of an NIR analysis device and a second analysis device in the form of an X-ray analysis device. The rock property or properties which are determined for the individual rock particle 3b are transmitted as a measurement signal(s) 25′ to an evaluation unit 27 for classifying each rock particle 3b. Each individual rock particle 3b is classified as a dead rock particle 23a or valuable mineral particle 23b as a function of its rock properties. The evaluation unit 27 outputs, on the basis of this sorting decision, a control signal 28 to a separating device 26 which performs mechanical sorting into dead rock particles 23a and valuable mineral particles 23b.

FIG. 4 shows a further sorting device 30′ in the form of a chute-type sorter for separating rock particles 3b from primary ore into dead rock and into a type of rock which is enriched with at least one valuable mineral, wherein the at least one valuable mineral comprises at least one rare earth mineral, and wherein the rock particles 3b comprise dead rock particles 23a composed of, or mainly composed of, dead rock, and also valuable mineral particles 23b composed of, or mainly composed of, rock which is enriched with a valuable mineral. The further sorting device 30′ comprises here a separating-out unit 24 for separating out the rock particles 3b in the form of a chute. The rock particles pass successively from the chute onto a slide 31 and are successively fed downward in a sliding fashion to a measuring unit 25. The latter comprises here a sensor unit 25a with an emitter unit E and a detector unit D and serves to analyze at least one primary and/or secondary rock property of each rock particle 3b and to assign at least one rock property to the respective rock particle 3b. The sensor-supported sorting is based on the principle of individual grain detection.

The rock property or properties which is/are determined for the individual rock particle 3b is/are transmitted as a measurement signal(s) 25′ to an evaluation unit 27 for classifying each rock particle 3b. Each individual rock particle 3b is classified as a dead rock particle 23a or valuable mineral particle 23b depending on its rock properties. The evaluation unit 27 outputs, on the basis of this sorting decision, a control signal 28 to a separating device 26 which performs mechanical sorting, here by means of a gas which flows out in a surging fashion, into dead rock particles 23a and valuable mineral particles 23b.

FIG. 5 shows a system 100 for separating primary ore 1 into dead rock and at least one type of rock which is enriched with at least one valuable mineral, wherein the at least one valuable mineral comprises at least one rare earth mineral. The system 100 comprises, in an input region I, a crusher 2 for comminuting the fragmented primary ore 1 into rock particles 3b with a relatively small maximum granular size, wherein the rock particles 3b comprise dead rock particles 23a composed of, or mainly composed of, dead rock and also valuable mineral particles 23b composed of, or mainly composed of, rock which is enriched with a valuable mineral. The system 100 also comprises a transfer region II for transferring the rock particles 3b to a sorting device which is located in the region III.

Upstream of the sorting device there is preferably a classification device in order to transfer only rock particles of a certain granular size range to the sorting device.

In the transfer region II there is a separating-out unit 24 for separating out the rock particles 3b. The separating-out unit 24 is therefore not part of the sorting device, in contrast to the sorting devices as shown in FIGS. 3 and 4.

In the region III of the sorting device there is a measuring unit 25 for sensing a primary rock property with a sensor unit 25a and a secondary rock property with a further active sensor unit 25a′. The further sensor unit 25a′ has an emitter unit E which is arranged above the transportation belt 29, and a detector unit D, which is arranged underneath the transportation belt 29. The analysis signal 25″ which is generated by the sensor unit 25a, and also the analysis signal 25′ which is generated by the further sensor unit 25a′, are transmitted to an evaluation unit 27. The two analysis signals 25′, 25″ are assigned to the rock particle 3b, and the latter is classified as a dead rock particle 23a or valuable mineral particle 23b by means of the evaluation unit 27, as a function of the determined rock properties. The evaluation unit 27 outputs, on the basis of this sorting decision, a control signal 28 to the separating device 26 which is also present and which performs mechanical sorting into dead rock particles 23a and valuable mineral particles 23b.

A system according to the invention can have further system components such as, for example, a classification stage which is connected between the crusher 2 and the chute and has the purpose of separating off excessively coarse rock particles downstream of the crusher 2 and of feeding them back in to the crusher 2, as is shown by numbers 3 and 3a in FIG. 1 or FIG. 2. Furthermore, the system can have system components which adjoin the region III, for example a milling stage for the valuable mineral particles 23b, a pre-flotation means, a cleaning flotation stage etc., as illustrated in FIG. 1 starting from the milling stage 4.

A system according to the invention can also have a plurality of separating-out units connected downstream of a crusher, wherein in each case one or more sorting devices which operate in parallel can adjoin a separating-out unit. As a result, the time required for the individual grain sorting process is significantly shortened. The stream of valuable mineral particles originating from the sorting devices which operate in parallel can be combined and treated, for example, in accordance with the sequence according to FIG. 1, starting from the milling stage 4.

FIG. 6 shows a further system 100′ for separating primary ore into dead rock 23a and into a type of rock 23b which is enriched with a valuable mineral, wherein separation also occurs into two fractions of valuable mineral particles, specifically comprising, on the one hand, first valuable mineral particles 23b′, enriched with light rare earth elements, and, on the other hand, comprising second valuable mineral particles 23b″, enriched with heavy rare earth elements. The same reference symbols as in FIG. 5 characterize identical elements. The analysis signal 25″ which is generated by the sensor unit 25a, and the analysis signal 25′ which is generated by the further sensor unit 25a′, are also transmitted here to an evaluation unit 27. The two analysis signals 25′, 25″ are assigned to the rock particle 3b and the latter is classified as a dead rock particle 23a, first valuable mineral particle 23b′ or second valuable mineral particle 23b″ by means of the evaluation unit 27, as a function of the rock particles which are determined. The evaluation unit 27 outputs, on the basis of this sorting decision, a control signal 28 to the separating device 26 which is also present and which performs mechanical sorting into dead rock particles 23a, first valuable mineral particles 23b′, and second valuable mineral particles 23b″. The first valuable mineral particles 23b′ and the second valuable mineral particles 23b″ can then be fed separately from one another and selectively to a preparation process which is tailored to the respectively mainly included different minerals.

As an alternative to the system 100′ illustrated by way of example in FIG. 6, it is, of course, also possible that, proceeding from the system 100 according to FIG. 5, the valuable mineral particles 23b are firstly separated off, as illustrated, and these are then separated out in a further subsequent sorting device, analyzed and separated into first valuable mineral particles and second valuable mineral particles. The expenditure in terms of apparatus and time is, however, correspondingly increased here, and the direct separation into dead rock particles 23a, first valuable mineral particles 23b′ and second valuable mineral particles 23b″ according to FIG. 6 is therefore the preferred solution.

1.-12. (canceled)

13. A method for separating primary ore containing rare earths into dead rock and at least one type of rock which is enriched with at least one valuable mineral which contains at least one rare earth mineral, said method comprising:
comminuting the primary ore into rock particles having a particle size in a range from >1 mm to 300 mm and composed at least mainly of dead rock and also valuable mineral particles composed at least mainly of rock which is enriched with a valuable mineral;
separating out the rock particles;
feeding the separated-out rock particles to at least one measuring unit;
determining by the at least one measuring unit at least two different rock properties of each of the rock particles, with at least one of the two different rock properties being a secondary rock property of the rock particle;
assigning the at least one secondary rock property to the rock particle;
classifying each rock particle as a function of its rock properties as a dead rock particle or valuable mineral particle; and
separating the dead rock particles from the valuable mineral particles.

14. The method of claim 13, wherein another one of the two different rock properties, determined by the at least one measuring unit, is a primary rock property.

15. The method of claim 14, wherein the primary rock property is a type of at least one contained valuable mineral and/or a valuable mineral content.

16. The method of claim 13, wherein the secondary rock property is a member selected from the group consisting of atomic density, magnetic susceptibility, natural radioactivity, visual property, type or content of accompanying minerals, alteration minerals, or elements which occur associated with the at least one rare earth mineral.

17. The method of claim 16, wherein the visual property is a color.

18. The method of claim 13, wherein the valuable mineral particles are separated into first valuable mineral particles and second valuable mineral particles, further comprising enriching the first valuable mineral particles with heavy rare earth elements, and enriching the second valuable mineral particles with light rare earth elements.

19. A sorting device for separating rock particles composed of primary ore into dead rock and at least one type of rock which is enriched with at least one valuable mineral, wherein the at least one valuable mineral comprises at least one rare earth mineral, and wherein the rock particles comprise dead rock particles which are at least mainly composed of dead rock, and also contain valuable mineral particles at least mainly composed of rock which is enriched with a valuable mineral, said sorting device comprising:
at least one separating-out unit configured to separate out the rock particles;
at least one measuring unit configured to analyze at least one secondary rock property of each rock particle and for assigning the at least one rock property to the rock particle, said measuring unit comprising at least two sensor units for analyzing different rock properties of a rock particle;
at least one evaluation unit configured to classify each rock particle as a function of its rock properties as a dead rock particle or a valuable mineral particle; and
at least one separating unit configured to separate the dead rock particles from the valuable mineral particles.

20. The sorting device of claim 19, wherein the at least one separating unit is configured to separate the valuable mineral particles into first valuable mineral particles and second valuable mineral particles, said first valuable mineral particles being enriched with heavy rare earth elements, and said second valuable mineral particles being enriched with light rare earth elements.

21. The sorting device of claim 19, wherein the separating-out unit includes a chute-type sorter and/or a transportation belt receiving the rock particles from the chute-type sorter.

22. The sorting device of claim 19, wherein one of the sensor units includes at least one emitter unit and/or at least one detector unit.

23. The sorting device of claim 22, wherein the one of the sensor units comprises at least one analysis device selected from the group consisting of optical analysis device, NIR analysis device, X-ray analysis device, X-ray fluorescence analysis device, analysis device using ionizing radiation, radiometric analysis device, inductive analysis device, LIBS analysis device, and microwave analysis device.

24. The sorting device of claim 19, wherein the at least one valuable mineral has a content of the at least one rare earth mineral of >0.1% by weight.

25. A system for separating primary ore into dead rock and at least one rock which is enriched with at least one valuable mineral, wherein the at least one valuable mineral comprises at least one rare earth mineral, said system comprising:
at least one crusher configured to comminute the primary ore into rock particles;
at least one sorting device including at least one separating-out unit configured to separate out the rock particles, at least one measuring unit configured to analyze at least one secondary rock property of each rock particle and for assigning the at least one rock property to the rock particle, said measuring unit comprising at least two sensor units for analyzing different rock properties of a rock particle, at least one evaluation unit configured to classify each rock particle as a function of its rock properties as a dead rock particle or a valuable mineral particle, and at least one separating unit configured to separate the dead rock particles from the valuable mineral particles;
at least one transfer region for transferring the rock particles to the at least one sorting device,
said at least one separating-out unit being arranged in the at least one transfer region and/or in a region of the at least one sorting device.

26. The system of claim 25, wherein the at least one separating unit is configured to separate the valuable mineral particles into first valuable mineral particles and second valuable mineral particles, said first valuable mineral particles being enriched with heavy rare earth elements, and said second valuable mineral particles being enriched with light rare earth elements.

27. The system of claim 25, wherein the separating-out unit includes a chute-type sorter and/or a transportation belt receiving the rock particles from the chute-type sorter.

28. The system of claim 25, wherein one of the sensor units includes at least one emitter unit and/or at least one detector unit.

29. The system of claim 28, wherein the one of the sensor units comprises at least one analysis device selected from the group consisting of optical analysis device, NIR analysis device, X-ray analysis device, X-ray fluorescence analysis device, analysis device using ionizing radiation, radiometric analysis device, inductive analysis device, LIBS analysis device, and microwave analysis device.

30. The system of claim 25, wherein the at least one valuable mineral has a content of the at least one rare earth mineral of >0.1% by weight.
